(19) United States
(12) Patent Application Publication
(10) Pub. No.: US 2007/0064556 A1
(43) Pub. Date: Mar. 22, 2007

(54) RECORDING APPARATUS

(75) Inventor: Kazuhito TANEOKA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/533,449

(22) Filed: Sep. 20, 2006

(30) Foreign Application Priority Data
Sep. 22, 2005 (JP) P2005-274996

(51) Int. Cl. G11B 19/02

(52) U.S. Cl. 369/47.1

(57) ABSTRACT

A recording apparatus comprises a first recording medium and a second recording medium. The first recording medium stores compressed-selected resources among code data in a compressed state. The compressed-selected resources are used in relation to usage modes. The second recording medium temporarily stores an uncompressed-selected resource that is obtained from a compressed-selected resource among the compressed-selected resources in uncompressed state. The uncompressed-selected resource is used in relation to a usage mode that is selected from among the usage modes. The uncompressed-selected resource that is temporarily stored in the second recording medium is stored in the first recording medium in an uncompressed state. The code data are used for indication on a display unit.

### BACKGROUND OF THE INVENTION

1. Field of the Invention

The present invention relates to a recording apparatus, and in particular to a recording apparatus to separately store (selected) resources that are used in relation to usage modes and a (common) resource that is used regardless of the usage mode.

2. Description of the Related Art

An apparatus whose usage modes, such as an indication language mode, can be selected by the operator is proposed.

Japanese Language Unexamined Patent Publication (KOKAI) No. H09-244901 discloses an image processing apparatus that comprises a flash memory that stores a first program that is always used in an uncompressed state, and a hard disk that stores a second program that is not always used in a compressed state. The second program is properly unpacked, and is stored in the flash memory, when the second program is necessary.

However, whenever the second program is used, unpacking the compressed second program is necessary; therefore the required time for booting the second program becomes long.

When the second program is stored in an uncompressed state, the required time for booting the second program does not become long; however, a recording medium that has a large capacity becomes necessary.

### SUMMARY OF THE INVENTION

Therefore, an object of the present invention is to provide a recording apparatus that stores resources in relation to usage modes without needing a large capacity and requiring a long boot time.

According to the present invention, a recording apparatus comprises a first recording medium and a second recording medium.

The first recording medium stores compressed-selected resources among code data in a compressed state. The compressed-selected resources are used in relation to usage modes.

The second recording medium temporarily stores an uncompressed-selected resource that is obtained from a compressed-selected resource among the compressed-selected resources in uncompressed state. The uncompressed-selected resource is used in relation to a usage mode that is selected from among the usage modes.

The uncompressed-selected resource that is temporarily stored in the second recording medium is stored in the first recording medium in an uncompressed state.

The code data are used for indication on a display unit.

### BRIEF DESCRIPTION OF THE DRAWINGS

The objects and advantages of the present invention will be better understood from the following description, with reference to the accompanying drawings in which:

FIG. 1 is a construction of a photographing apparatus in the embodiment;

FIG. 2 is a construction of a recording field of a first recording medium;

FIG. 3 is an illustration of the setting of the time and date in the Japanese language;

FIG. 4 is an illustration of the setting of the time and date in the English language; and

FIG. 5 is a flowchart that shows a process from when the power supply of the photographing apparatus is set to an on state to when the photographing apparatus is set to a standby state in which an imaging operation can be performed.

### DESCRIPTION OF THE PREFERRED EMBODIMENTS

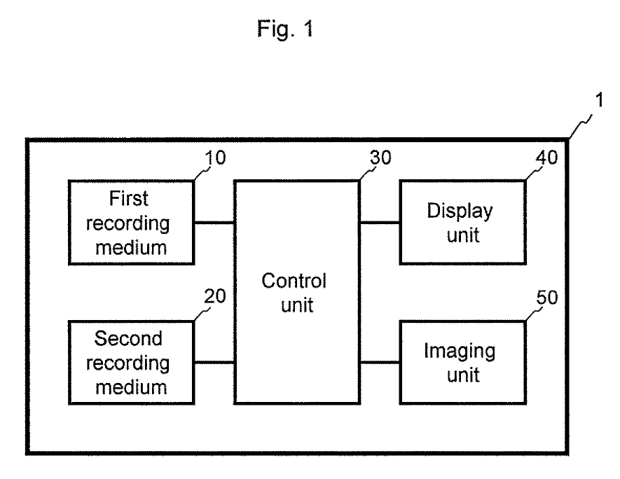

The present invention is described below with reference to the embodiment shown in the drawings. As shown in FIG. 1, a photographing apparatus 1 comprises a first recording medium 10, a second recording medium 20, a control unit 30, a display unit 40, and an imaging unit 50. In the embodiment, the photographing apparatus 1 is a digital camera; however, the photographing apparatus 1 may be another type of camera.

The first recording medium 10 is a recording medium in which a stored content is not deleted even if a power supply for the recording medium is set to the off state; for example, a program flash ROM (a flash memory). The first recoding medium 10 has a first field 101, a second field 102, a third field 103, a fourth field 104, a fifth field 105, and a sixth field 106.

The second recording medium 20 is a recording medium in which a stored content is deleted when a power supply for the recording medium is set to the off state; for example, an SDRAM (Synchronous Dynamic Random Access Memory).

The control unit 30 is an apparatus that controls each part of the photographing apparatus 1; for example, a DSP (Digital Signal Processor).

The display unit 40 is an apparatus that indicates an image that is obtained by an imaging operation and information regarding the operation.

The imaging unit 50 has an imaging device and performs the imaging operation.

Code data that are used for indicating information regarding operation on the display unit 40 are stored in the first recording medium 10 in advance.

Among the code data, each of a plurality of language resources has at least one of a character datum and a figure datum. Each of the language resources is used in conjunction with an indication language mode that is selected in a plurality of indication language modes of the photographing apparatus 1. The language resources are compressed and stored in the plurality of fields (the first field 101, the second field 102, the third field 103, and the fourth field 104) corresponding to the plurality of indication language modes.

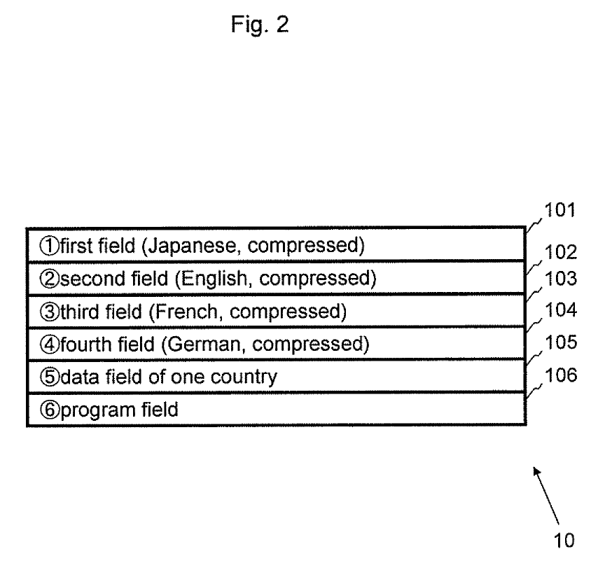

As shown in FIG. 2, a language resource regarding the Japanese language is compressed and stored in the first field 101 as a first language resource.

A language resource regarding the English language is compressed and stored in the second field 102 as a second language resource.

A language resource regarding the French language is compressed and stored in the third field 103 as a third language resource.

A language resource regarding the German language is compressed and stored in the fourth field 104 as a fourth language resource.

However, the kind of language is not limited to languages used in the four countries in the embodiment.

The language resource from among the first, second, third, and fourth language resources corresponding to the indication language mode that is selected by the operator, is stored in the fifth field 105 in an uncompressed state after unpacking from the compressed state.

For example, in the indication language mode of the photographing apparatus 1, when the indication language mode corresponding to the Japanese language is selected by the operator, the first language resource that is stored in the first field 101 in a compressed state, is unpacked and is stored in the fifth field 105 in an uncompressed state. Next, when another indication language mode is selected, the first language resource that is stored in the fifth field 105 is deleted, and the other language resource corresponding to the other language mode is stored in the fifth field 105.

The storage operation (writing operation) to the fifth field 105 from one of the first, second, third and fourth fields 101, 102, 103, and 104 is performed through the second recording medium 20.

Among the code data, a common resource has at least one of a character datum and a figure datum. The common resource is used regardless of the indication language mode. The common resource is stored in a program field that is the sixth field 106. The common resource may be stored in a compressed state or in an uncompressed state. If the common resource is stored in the sixth field 106 in a compressed state, the common resource is properly unpacked, when at least one of a character datum and a figure datum of the common resource is necessary.

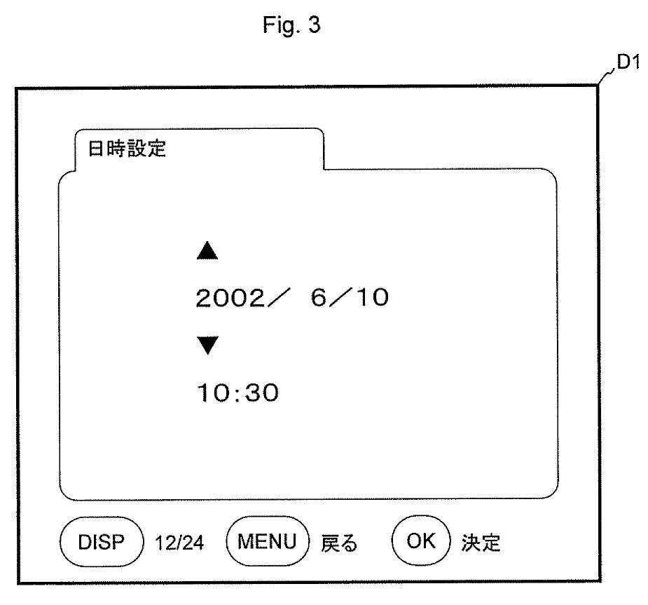

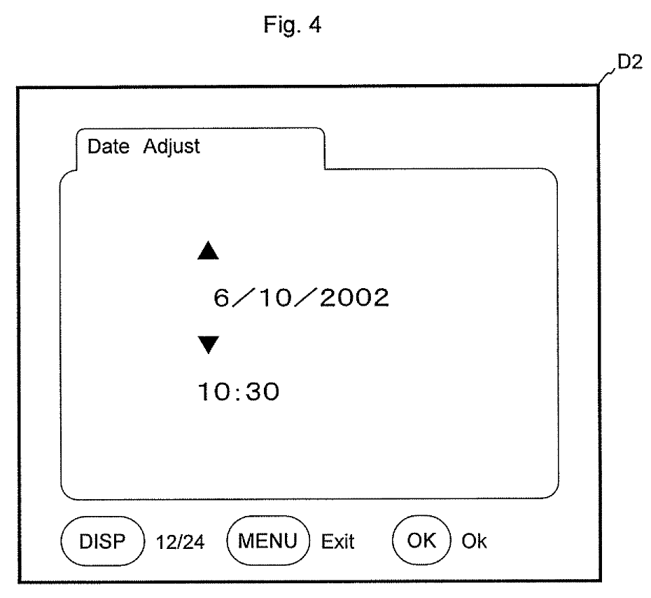

The language resource is information regarding characters and figures that is used only for the selected indication language mode. For example, as shown in FIG. 3, in a first picture D1 that is used for setting the time and date, data corresponding to the characters of “ [symbol] ”, “ [symbol] [symbol] ”, and “ [symbol] ” are the character data that are stored in the first field 101 as the first language resource. As shown in FIG. 4, in a second picture D2 that is used for setting the time and date, data corresponding to the characters of “Date Adjust”, “Exit”, and “Ok” are the character data that are stored in the second field 102 as the second language resource.

The common resource is information regarding characters and figures that can be used for any indication language mode. For example, in the first and second pictures D1 and D2, data corresponding to a folder-shaped figure, and to the characters of “DISP”, “12/24”, “MENU”, and “OK”, which are used for both the indication language mode corresponding to the Japanese language and the indication language mode corresponding to the English language are stored in the sixth field 106 as the common resource.

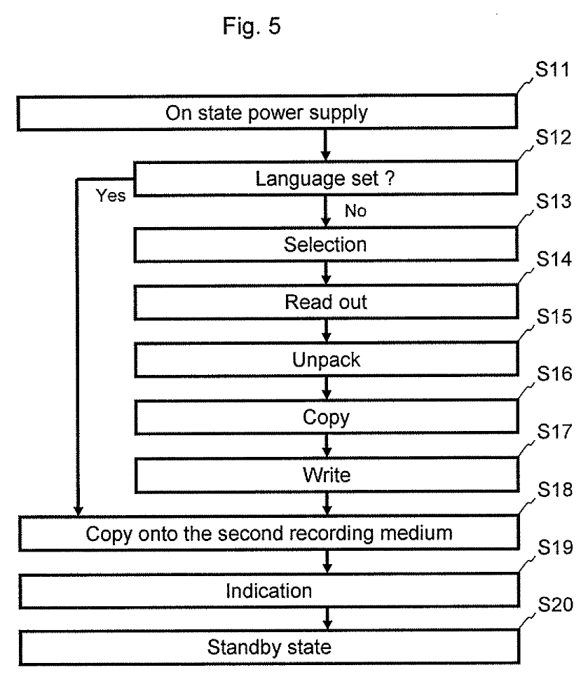

As shown in FIG. 5, a process in which one of the first, second, third, and fourth language resources that are stored in the first, second, third, and fourth fields 101, 102, 103, and 104 of the first recording medium 10 is selected and stored in the fifth field 105, is explained.

In step S11, the power supply of the photographing apparatus 1 is set to the on state. In step S12, it is judged whether the indication language mode of the photographing apparatus 1 has already been set.

If the indication language mode has already been set and a change of the indication language mode is not necessary, the flow is forwarded to step S18.

If the indication language mode has not been set yet or a change to another indication language mode from the present indication language mode that has already been set is necessary, the flow is forwarded to step S13.

In step S13, the language that is used for the photographing apparatus 1 is selected by the operator. Specifically, the indication language mode that the operator wants to use for operating keys on the display unit 40 is selected on the basis of information displayed on a graphic screen for selecting the indication language mode that is indicated on the display unit 40.

In step S14, the language resource corresponding to the indication language mode that is selected by the operator is read out from one of the first, second, third, and fourth fields 101, 102, 103, and 104 onto the second recording medium 20.

Specifically, when the indication language mode corresponding to the Japanese language is selected, the first language resource, which is stored in the first field 101 in a compressed state, is read out onto the second recording medium 20.

When the indication language mode corresponding to the English language is selected, the second language resource, which is stored in the second field 102 in a compressed state, is read out onto the second recording medium 20.

When the indication language mode corresponding to the French language is selected, the third language resource, which is stored in the third field 103 in a compressed state, is read out onto the second recording medium 20.

When the indication language mode corresponding to the German language is selected, the fourth language resource, which is stored in the fourth field 104 in a compressed state, is read out onto the second recording medium 20.

In step S15, the compressed state of the language resource that is read out is unpacked onto the second recording medium 20. However, the read-out operation in step S14 and the unpacking operation in step S15 may be performed at the same time. That is, the language resource corresponding to the indication language mode that is selected by the operator may be read out onto the second recording medium 20 during unpacking.

In step S16, the unpacked language resource is copied (temporarily stored) onto the second recording medium 20.

In step S17, the language resource that is copied onto the second recording medium 20 with in an uncompressed state, is written (stored) in the fifth field 105 of the first recording medium 10. After that, the unpacked language resource that is copied (temporarily stored) onto the second recording medium 20 is deleted (cut and pasted).

Therefore, a field in the second recording medium 20 that is used for writing the language resource to the fifth field 105 and that temporarily stores the unpacked language resource can be used for another use. An alternative use is to store a program or a datum for operating the photographing apparatus 1 in a state of ordinary usage.

If the language resource corresponding to the indication language mode has already been stored (written) in the fifth field 105 in step S17, the language resource that has already been stored is deleted, and the unpacked language resource that is copied (temporarily stored) onto the second recording medium 20 is written (overwrites the existing data) onto the fifth field 105.

In step S18, at least one of the character datum and the figure datum of the language resource in the fifth field 105 that is used for indication on the display unit 40 is copied (temporarily stored) onto the second recording medium 20.

Further, at least one of the character datum and the figure datum of the common resource in the sixth field 106 that is used for indication on the display unit 40 is copied (temporarily stored) onto the second recording medium 20. If the common resource is stored in the sixth field 106 in a compressed state, at least one of the character datum and the figure datum of the common resource in the sixth field 106 that is used for indication on the display unit 40 is unpacked and then copied (temporarily stored) onto the second recording medium 20.

A simple datum (for example, a color of the background of a picture, etc.) may be written onto the second recording medium directly by the control unit 30 or another suitable devise without storage on the first recording medium 10.

In step S19, an indication is performed on the display unit 40 on the basis of at least one of the character datum and the figure datum that is copied onto the second recording medium 20.

In step S20, the photographing apparatus 1 is set to a standby state, where the imaging operation can be performed.

The indication in step S19 is performed in state where the datum of the language resource and the datum of the common resource overlap. Specifically, a picture datum is made and indicated, after the datum of the language resource and the datum of the common resource overlap (are superimposed).

In the embodiment, the first, second, third, and fourth language resources excluding the language resource corresponding to the selected indication language mode, are stored in the first recording medium 10 in a compressed state. Therefore, the quantity (file size) for storing the language resources can be downsized compared to the case in which the language resources are stored in the first recording medium 10 in an uncompressed state.

The language resource that is stored in the fifth field 105 in an unpacked state remains without being deleted, even if the power supply to the photographing apparatus 1 is set to the off state.

Therefore, after the power supply to the photographing apparatus 1 is set to the off state, the entire process in which the indication language mode is first selected, one of the first, second, third, and fourth language resource is then unpacked, and the unpacked language resource is next written onto the fifth field 105 through the second recording medium 20, can be omitted.

Accordingly, the boot period from the time when the photographing apparatus 1 is set to the on state from the off state to the time when the photographing apparatus 1 is set to a standby state where the imaging operation can be performed does not become long compared to the case in which all the language resources are stored in the first recording medium 10 in an uncompressed state.

The second recording medium 20 is used for temporarily storing the data that is stored in the first recording medium 10 or one of the other recording media so that even if the stored content of the second recording medium 20 is deleted when the power supply to the photographing apparatus 1 is cut, the usage of the photographing apparatus 1 is not influenced by the stored content being deleted.

A problem regarding the usage of the photographing apparatus 1 d

Further, the operation of the language setting has priority over other operations, and is performed when the photographing apparatus 1 is in the boot period (after the power supply to the photographing apparatus 1 is set to the on state). After operating of language setting, a field in the second recording medium 20 that is used for temporarily storing the language resource and for writing the language resource to the fifth field 105 becomes a vacant space.

Therefore, the vacant space, which is the field in the second recording medium 20, can be used as a field for storing the program or the datum for other operations, so that the storage field of the second recording medium 20 can be used efficiently.

The other operations in the embodiment are all of the operations that are performed on the photographing apparatus 1, except for operating (managing) the language setting.

In the embodiment, among the code data, the language resources (the character datum or the figure datum) are used in relation to the indication language mode that is selected from a plurality of indication language modes of the photographing apparatus 1. Each of the language resources is stored in the field corresponding to the plurality of indication language modes (the first, second, third, and fourth fields 101, 102, 103, and 104) in a compressed state.

Among the code data, the common resource that is used regardless of the indication language mode is stored in the program field (the sixth field 106).

However, the usage mode that can be selected by the operator is not limited to the indication language mode. For example, among the code data, the compressed-selected resources may be used in relation to the usage mode that is selected from a plurality of usage modes of the photographing apparatus 1. Each of the compressed-selected resources is stored in the field corresponding to the plurality usage modes (the first, second, third, and fourth fields 101, 102, 103, and 104) in a compressed state.

Among the code data, the common resource may be used regardless of the usage mode, and is stored in the program field (the sixth field 106).

As to the usage mode, a first usage mode regarding the indication language where a Japanese indication mode and an English indication mode are switched, a second usage mode regarding a method of setting of the exposure where a shutter speed priority AE mode and an aperture priority AE mode are switched, and a third usage mode regarding a help function where a help mode for beginner and a help mode for expert are switched are available.

The first recording medium 10 and the second recording medium 20 are set in the photographing apparatus 1 in the embodiment. However, they may also be set in another apparatus.

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2005-274996 (filed on Sep. 22, 2005), which is expressly incorporated herein, by reference, in its entirety.

1. A recording apparatus, comprising:
a first recording medium that stores compressed-selected resources among code data in a compressed state, said compressed-selected resources being used in relation to usage modes, said code data being used for indication on a display; and
a second recording medium that temporarily stores an uncompressed-selected resource that is obtained from a compressed-selected resource among said compressed-selected resources in an uncompressed state, said uncompressed-selected resource being used in relation to a usage mode that is selected from among said usage modes;
said uncompressed-selected resource, which is temporarily stored in said second recording medium, being stored in said first recording medium in an uncompressed state.

2. The recording apparatus according to claim 1, wherein said first recording medium is a recording medium where a stored content is not deleted even if a power supply to said first recording medium is set to the off state; and
said second recording medium is a recording medium where a stored content is deleted when a power supply to said second recording medium is set to the off state.

3. The recording apparatus according to claim 2, wherein said first recording medium is a flash ROM; and
said second recording medium is an SDRAM.

4. The recording apparatus according to claim 1, wherein said usage mode is used for indication on said display unit, and is an indication language mode that is selected by an operator.

5. The recording apparatus according to claim 1, wherein said first recording medium stores a common resource among said code data that is used regardless of said usage mode.

6. The recording apparatus according to claim 1, wherein at least one of a character datum and a figure datum that is used for indication on said display unit among said uncompressed-selected resource that is stored in said first recording medium in an uncompressed state, is temporarily stored in said second recording medium, and said indication is displayed on said display unit on the basis of said at least one of said character datum and said figure datum that is temporarily stored in said second recording medium, when at least one of a character and a figure corresponding to said at least one of said character datum and said figure datum is indicated on said display unit.

7. An operating method of a recording apparatus comprising:
unpacking a selected resource among selected resources stored in a first recording medium in a compressed state among code data used in relation to usage modes, said selected resource among said selected resources being used in relation to a usage mode that is selected from among said usage modes, said code data being used for indication on a display unit;
temporarily storing in a second recording medium said unpacked selected resource; and
storing in said first recording medium in an uncompressed state said unpacked selected resource that is temporarily stored in said second recording medium in an uncompressed state.

8. The operating method of said recording apparatus according to claim 7,
wherein in said storing, when another unpacked selected resource has already been stored in said first recording medium in an uncompressed state, said unpacked selected resource that is temporarily stored in said second recording medium in an uncompressed state is stored in said first recording medium after said another unpacked selected resource is deleted.

9. The operating method of said recording apparatus according to claim 7, further comprising:
temporarily storing in said second recording medium at least one of a character datum and a figure datum that is used for indication on said display unit among said unpacked selected resource that is stored in said first recording medium in an uncompressed state
displaying an indication on said display unit on the basis of said at least one of said character datum and said figure datum that is temporarily stored in said second recording medium.

10. The operating method of said recording apparatus according to claim 71
wherein said recording apparatus is used for a photographing apparatus; and
wherein said unpacking, temporarily storing and storing have priority over other operations of said photographing apparatus, and are performed when said photographing apparatus is in the boot period.
